(19) United States
(12) Patent Application Publication
(10) Pub. No.: US 2026/0270602 A1
(43) Pub. Date: Sep. 10, 2026

(54) EARCUP FOR HEADPHONES

(71) Applicant: Sony Interactive Entertainment Inc., Tokyo (JP)

(72) Inventors: Calum Armstrong, London (GB); Michael Lee Jones, London (GB)

(21) Appl. No.: 19/559,313

(22) Filed: Mar. 6, 2026

(30) Foreign Application Priority Data
Mar. 7, 2025 (GB) 2503336.6

(51) Int. Cl. H04R 1/10

(52) U.S. Cl. CPC H04R 1/1041; H04R 1/1008; H04R 1/1075; H04R 1/1083; H04R 2460/01

(57) ABSTRACT

An earcup for a set of headphones includes: an actuator and a housing, wherein the earcup is operable, by the actuator, to alternate between being in an open state and a closed state, wherein the housing is arranged in an open-back configuration when the earcup is in the open state, and the housing is arranged in a closed-back configuration when the earcup is in the closed state.

### CROSS-REFERENCE TO RELATED APPLICATIONS

This application claims priority to United Kingdom Application No. 2503336.6, filed on March 7, 2025, the contents of which are incorporated herein by reference.

### TECHNICAL FIELD

The present disclosure is in the field of headphone technology.

### BACKGROUND

Closed-back headphones have been the default design of headphones available to retail and corporate consumers for some time. In a closed-back configuration, the earcup housing is sealed to block sound from leaking out to the surroundings and external noise from leaking in from the surroundings. This sealed design provides an isolated sound environment which traps air and permits better low-frequency pressure buildup. In terms of the sound profile, closed-back headphones offer an enhanced bass response and an intimate soundstage on account of their design. These headphones are ideal for commuting, noisy environments, and scenarios where sound isolation is crucial (e.g. live recording).

On the other hand, open-back headphones have typically been confined to high-end and professional audio markets. Lauded by audiophiles, the earcup housing in an open-back configuration has openings which reduce reflections and permit air and sound to pass relatively freely between the loudspeaker driver and the external environment. In terms of sound profile, open-back headphones offer less bass isolation but a wider, open and more natural soundstage similar to listening through a HiFi speaker system. Though bass frequencies may be less pronounced due to the lack of air pressure buildup, this unsealed design permits external sounds to mix with the audio, making it more ideal for studio use and quieter environments. These headphones have been preferred for critical listening, studio mixing, and enjoying detailed audio at home.

However, it has not yet been possible to provide headphones that is able to provide the advantages of both a closed-back configuration to an open-back configuration. The problem thus arises of providing a earcup for a set of headphones that can allow for adjustable properties to provide the above described advantages of both open and closed cup headphones.

### SUMMARY

According to an aspect of the disclosure, there is provided an earcup for a set of headphones, the earcup including: an actuator and a housing, wherein the earcup is operable, by the actuator, to alternate between being in an open state and a closed state, wherein the housing is arranged in an open-back configuration when the earcup is in the open state, and the housing is arranged in a closed-back configuration when the earcup is in the closed state. This adaptable and convenient earcup design provides the option to adjust the sound profile of the set of headphones based on the external listening environment and personal sound preferences.

In an example, the housing is configured to arrest (i.e. restrict and/or prevent) airflow through the housing when the earcup is in the closed state. Preferably, the housing is configured to form a hermetic seal when the earcup is in the closed state. For the closed-back configuration, ensuring a good seal (and in some cases an airtight seal) is critical to maintain sound isolation and bass performance.

In an example, the housing is configured to permit airflow through the housing when the earcup is in the open state. For the open-back configuration, ensuring airflow into the earcup (i.e. to carry external noise) and out of the earcup (i.e. to carry sound produced by the driver) is critical to provide the natural soundstage.

In an example, the housing includes an attachable / detachable plate (or cover or panel), one or more attachment features corresponding to the plate, and one or more apertures, wherein the plate is configured to attach to (and thereafter detach from / reattach to) the earcup by the one or more corresponding attachment features, the plate when attached is configured to cover the aperture(s) so as to provide the closed-back housing configuration, and the plate when detached is configured to uncover the aperture(s) so as to provide the open-back housing configuration. The attaching/detaching may occur by way of manual operation. In such examples, the actuator comprises a handle or grip disposed on or otherwise connected to the plate whereby the housing is manually operable to alternate between being in the open-back configuration and the closed-back configuration.

In some examples, the attachment feature(s) may include one or more grooves and/or one or more magnetics on the housing which may configured to (slidably, magnetically, mechanically, or otherwise detachably) communicate with the plate during attaching/detaching of the plate and to maintain the attached plate in position until detachment is desired. Where the plate is slidably detachable to the earcup, the plate may comprise one or more protrusions or grooves configured to communicate with corresponding grooves on the housing. Where the plate is magnetically detachable to the earcup, the plate may comprise one or more magnets configured to communicate with the corresponding (but of opposite polarity) magnets of the attachment feature(s). In some examples, the attachment feature comprises a further latch mechanism configured to secure the plate in one of the open and closed configurations.

In an example, the housing includes one or more moveable blades, the one or more blades being operable, by the actuator, to move between the open-back configuration and the closed-back configuration whereby to alternate the earcup between being in the open state and the closed state respectively. The one or more moveable blades may be considered to define one or more corresponding variable apertures in the housing.

In an example, the housing includes a plurality of moveable blades, the plurality of blades being connected to one another such that the plurality of blades are operable, by the actuator, to move in unison between the open-back configuration and the closed-back configuration.

In an example, the housing includes a plurality of moveable blades, the plurality of blades being slidably connected to one another such that the plurality of blades are operable, by the actuator, to slide with respect to one another whereby to move between the open-back configuration and the closed-back configuration.

In an example, the one or more blades are in the form of a mechanical iris. The mechanical iris may comprise a single variable aperture.

In an example, the one or more blades are in the form of a grille. The grille may include one or more variable apertures.

In an example, the one or more blades include one or more respective slats, shutters, bars, or doors.

In an example, one or more lips are disposed on the respective one or more variable apertures and/or on the respective one or more moveable blades, the one or more lips being configured so as to form a hermetic seal when the earcup is in the closed state. In this way, adequate sealing is provided at the openings in the earcup otherwise used during the open state in order to prevent airflow during the closed state.

In an example, the actuator is an electronically operated actuator. Preferably, the earcup is operable, by the actuator, to alternate between being in the open state and the closed state upon actuation, by a user, of a switch.

In an example, the actuator is a manually operated actuator. Preferably, the actuator includes a handle or grip connected to at least one of the one or more blades whereby the earcup is manually operable to alternate between being in the open state and the closed state.

In an example, the earcup includes a latch mechanism, the latch mechanism being configured to secure the earcup in one or both of the open state and the closed state. Once a state change has occurred, the housing can remain in the new state (and operation of the actuator may cease) by means of the latch mechanism until the next state change is required. In this way, it is ensured that the earcup can only be in one configuration or the other rather than a mix of both, which could produce an undesirable sound profile.

In an example, the latch mechanism includes a magnet array, the magnet array including multiple magnets arranged on the housing such that the housing is secured, by magnetic forces, in the open-back configuration when the earcup is in the open state and in the closed-back configuration when the earcup is in the closed state.

In an example, the earcup is configured to bear a microphone, the microphone being configured to collect ambient noise in the proximity of the earcup. The collected ambient noise can in some examples be supplied to an ambient noise cancellation module for use in active acoustic isolation. This is particularly beneficial during the closed state when an isolated sound environment is desirable.

In an example, the earcup includes a signal processor, the signal processor being configured to estimate a noise level at the earcup based on the ambient noise collected by the microphone, and to control the actuator to operate the earcup between the open state and the closed state based on the estimated noise level. Accordingly, the earcup is adaptable based on the ambient noise near the user’s ear in order to provide the optimum listening experience in the given scenario.

In an example, the signal processor is configured to determine a denoise signal based on the estimated noise level, the denoise signal being configured to counteract the ambient noise in the proximity of the earcup. Preferably, the earcup is configured to bear a driver, and the signal processor is configured to output, by the driver, the denoise signal.

In an example, the earcup is configured to bear a driver, the driver being configured to output an output audio signal according to a received input audio signal.

In an example, the earcup includes a signal processor, the signal processor being configured to modify the to-be-output audio signal (i.e. to be output by the driver) based on the detected state of the earcup. Additionally or alternatively, the signal processor is configured to modify the to-be-output denoise signal (i.e. to be output by the driver) based on the detected state of the earcup. The resulting output audio signal reproduced at the driver is therefore enhanced according to the current earcup state.

In an example, the earcup includes a signal processer, the signal processor being configured to receive the input audio signal, and to control the actuator to operate the earcup between the open state and the closed state based on the received input audio signal. Accordingly, the earcup can be adapted based on the input audio and in particular whether the closed-back or open-back configuration is the optimum configuration for reproduction of the given input audio by the headphones.

According to another aspect , there is provided a set of headphones including one or more earcups according to an aspect of the disclosure.

In an example, the set of headphones includes two earcups, each earcup including an actuator and a housing, and the earcups being operable, by their respective actuators, to alternate between being in an open state and a closed state, wherein both housings are arranged in open-back configurations when the earcups are in the open state, and both housings are arranged in closed-back configurations when the earcups are in the closed state. In this way, each earcup is operable by a respective actuator to alternate each earcup between the open and closed states. The earcups are preferably in the same state at the same time, i.e., the earcups cannot be operated independently; alternatively, the earcups may be operated independently.

In an example, the set of headphones includes an actuator and two earcups, each earcup including a housing, and the earcups being operable, by the actuator, to alternate between being in an open state and a closed state, wherein both housings are arranged in open-back configurations when the earcups are in the open state, and both housings are arranged in closed-back configurations when the earcups are in the closed state. In this way, the earcups are operable by the same actuator to alternate both earcups between the open and closed states.

In an example, the set of headphones includes a switch connected to the actuator(s), wherein the one or more earcups are operable, by the actuator, to alternate between being in the open state and the closed state upon actuation, by a user, of the switch.

In an example, the set includes one or more drivers, one or more earpads disposed on the respective one or more earcups opposite the respective housing(s), a headband, one or more microphones, one or more signal processors, or one or more additional components. Optionally, the set comprises a microphone connected by a boom to at least one of the one or more earcups, the microphone being configured to receive sound produced by a user.

Though the description of each aspect has its own emphasis, for any feature, example or advantage that is not described in relation to one aspect, reference may be made to those of any other aspects.

Terms used in the present disclosure are hereinafter defined without reference to any particular embodiment(s) .

Herein, a headphone, headphones, or set of headphones are understood to mean a personal auditory or auricular device configured in use to fit in, on, or around the ear or both ears, and include any headphone design. Exemplary designs of headphone include but are not limited to: circumaural (over ear or around-ear) headphones, supra-aural (on-ear) headphones, wired (corded) headphones, wireless (cordless) headphones, air tube headphones, noise-cancelling headphones. Further exemplary headphones include but are not limited to: intra-aural (in-ear) audio devices, earphones, earbuds, earpieces, air buds, headsets (including specialised headsets for professional, corporate, office, aviation, commentary, or gaming scenarios), assistive listening devices, hearing aids, earmuffs, ear defenders. Typically, headphones are electroacoustic headphones which are configured to bear one or more drivers for use converting a received electrical audio signal into audible sound; such headphones may or may not include passive and/or active acoustic isolation. Alternatively, headphones are passive headphones which are configured for passive acoustic isolation only.

Herein, a driver is understood to mean a loudspeaker driver configured to reproduce an output audio signal in the form of audible sound based on an input audio signal in the form of an electrical signal. The driver for outputting audible sound according to the present disclosure is not limited herein. Exemplary drivers include but are not limited to: dynamic drivers, electrodynamic speaker drivers, moving coil drivers, planar magnetic (orthodynamic) drivers, electrostatic drivers, electret drivers, balanced armature drivers.

Herein, an audio input device is understood to mean an external device from which an input audio signal (and thereafter provided to a transducer and converted to audible sound for listening by a user) is received in use. The device from which electrical audio signals are received in this way according to the present disclosure is not limited herein. Exemplary audio input devices include but are not limited to: a terminal device, a user equipment, a mobile device, a tablet device, a computer including a laptop or desktop, studio recording equipment, a mixing console, a (video) gaming console, a portable media player, a digital audio player, a DVD or CD player, VR or AR equipment, a musical instrument, an audio induction loop (i.e. a hearing loop), an amplifier, a two-way radio transceiver, a smartwatch, a fitness tracker, a portable radio, an e-reader, an audiometer, an in-flight or in-vehicle entertainment or infotainment system.

Herein, a signal processor is understood to mean an audio signal processor which is configured to receive audio signal(s), manipulate the audio signal(s) according to an instruction, and output the resulting audio signal(s). The signal processor used according to the present disclosure is not limited herein; for example, it may be a digital or analogue signal processor. Typically, a signal processor or a plurality of signal processors is implemented on a chip, an integrated circuit, printed circuit board, one or more microprocessors, sound card or sound chip, or other specialised sound hardware, which is comprised in the headphones (or earcup thereof) together with a computer-readable storage medium and a battery which with the signal processor is connected in use.

### BRIEF DESCRIPTION OF THE DRAWINGS

Embodiments are hereinafter described by way of non-limiting examples and with reference to the accompanying drawings, wherein:

FIG. 1 is a drawing of an example earcup , wherein the earcup is applied to a headphone; and

FIG. 2 is a drawing of an example housing for an earcup .

### DETAILED DESCRIPTION

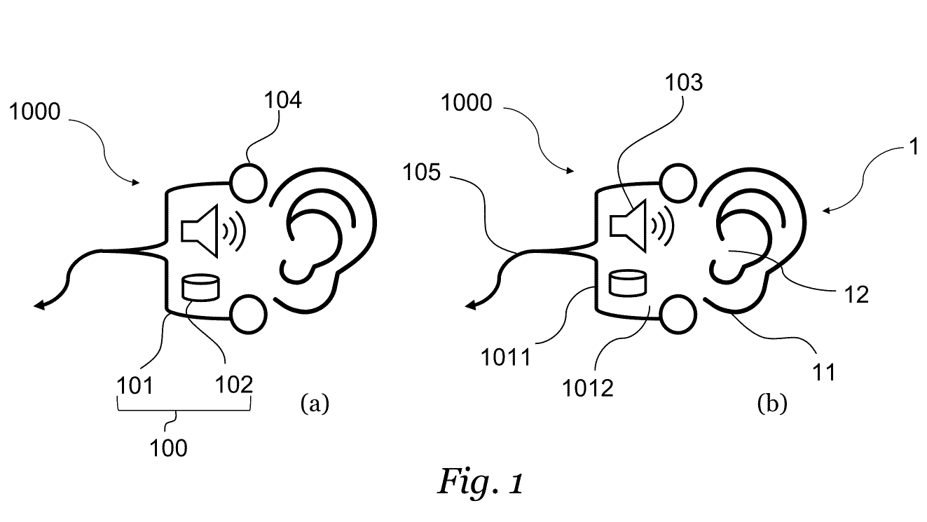

According to FIG. 1, there is provided an earcup 100. The earcup 100 includes at least a housing 101 and an actuator 102. In FIG. 1(a), the earcup 100 is in the closed state. In FIG. 1(b), the earcup 100 is in the open state. The earcup 100 is applied to and configured for use in headphones 1000.

In the example of FIG. 1, the headphones 1000 include at least the earcup 100 and may further include one or more additional components. The one or more additional components include but are not limited to: one or more transducers (such as one or more drivers 103), an earpad 104 (optionally includincluding one or more foam pads or cushions), one or more connections 105 (which may be electrical and/or mechanical in nature). Further such components which are not shown may include: one or more additional earcups, one or more processing units, one or more memory units (i.e. storage media), one or more batteries, a plug (e.g. a male phone connector), a charging port (e.g. a female power connector), one or more audio signal processors, passive and/or active acoustic isolation apparatus, an ambient noise cancellation module, a headband, one or more protective cloths, one or more dust filters, transceiver circuitry, one or more sensors, one or more microphones (optionally configured to receive sound produced by a user and/or receive ambient noise in the proximity of the headphones), a boom connecting at least one microphone and the headphones 1000 or earcup(s) 100 thereof.

Typically, the headphones 1000 include one earcup 100 and one or more additional components (optionally including one of each additional component). Alternatively, the headphones 1000 are a set of headphones, in which case the set of headphones includes at least two earcups 100 (optionally connected via: a headband configured to secure the headphones to the user’s head, or mechanical / electrical connections 105) and optionally one or more additional components. Alternatively still, the set of headphones includes a first earcup 100, a second earcup (not shown), and optionally one or more additional components, wherein the first earcup 100 and the second earcup include a housing 101 operated via connections 105 by the actuator 102 of the first earcup 100. Alternatively still, the set of headphones includes a first earcup 100, a third earcup (not shown), and optionally one or more additional components, , and the third earcup includes a housing configured to be permanently in a closed state or an open state. In any case, the multiple earcups included in a set of headphones may be served by the same (or alternatively distinct) audio input device(s) and/or by the same (or alternatively distinct) signal processor(s) and/or by the same (or alternatively distinct) actuator 102 and/or by the same (or alternatively distinct) additional components described herein.

Typically, the earcup 100 is an electroacoustic earcup. In this case, the earcup 100 is configured to bear one or more electroacoustic transducers (e.g. one or more drivers 103 shown in FIG. 1) i.e. devices configured to convert electrical signals (i.e. an input audio signal, a denoise signal, or an input audio signal modified according to the present disclosure) into audible sound (i.e. an output audio signal) or vice versa. In such examples, the earcup 100 may further include or be electrically connected to circuitry (including but not limited to one or more connections 105) which is configured to receive the input audio signal (and/or the denoise signal) from an audio input device (and/or an ambient noise cancellation module) and provide it to the transducer, which thereafter converts it into an output audio signal for direct listening by the user. Ambient noise cancellation is also referred to as active acoustic isolation and techniques therefor are known in the art and not described in detail herein. Optionally, the headphones 1000 may employ passive and/or active acoustic isolation apparatus in order to limit ambient noise for the listening user.

Alternatively, the earcup 100 is an entirely passive earcup, in which case the earcup 100 is configured to provide passive acoustic isolation (i.e. rather than generate sound) from ambient noise. Such an earcup 100 may be configured for use in (e.g. industrial) earmuffs or ear defenders. Techniques for passive acoustic isolation are known in the art and not described in detail herein.

As mentioned, the earcup 100 may be configured to bear a driver 103 which in use converts a received input audio signal into an output audio signal to be provided to or at a user’s ear 1. As shown in FIG. 1, the user’s ear 1 often includes an auricle 11 and a canal 12. The earcup 100 may also be configured to bear an earpad 104 which in use abuts a part of the user’s ear 1 or a part adjacent the user’s ear 1. Accordingly, the earpad 104 is typically disposed on the earcup 100 opposite the housing 101. The earpad 104 is configured to permit sound to pass in use from the driver 103 to the ear 1 and particularly the ear canal 12, for example by means of a central aperture formed in the earpad. Accordingly, the earpad 104 is typically disposed on a rim of the earcup 100 adjacent the ear 1. Furthermore, the earcup 100 may include a protective cloth disposed between the driver 103 and the ear 100, optionally disposed over the central aperture of the earpad 104.

In the case shown in FIG. 1 in which the earcup 100 is applied to supra-aural headphones, the earpad 104 is configured in use to abut the user’s auricle 11; in the case that the earcup 100 is applied to intra-aural headphones (not shown), the earpad 104 is positioned in use within or just without the canal 12; in the case that the earcup 100 is applied to circumaural headphones (not shown), the earpad 104 is positioned in use such that the auricle 11 is substantially surrounded by the earcup 104. Other cases will be readily apparent to the skilled addressee and the headphone design (and therefore the configuration of the earpads 104) is not limited herein; for example, the headphones 1000 may include a combination of both circumaural and supra-aural earpads etc. However, in each case the earcup 100 will be configured for the particular headphone design (e.g. the earpad configuration thereof).

As mentioned, the earcup 100 may be configured to connect to one or more additional components via connection(s) 105 shown as an arrow in FIG. 1. The one or more additional components include but are not limited to: another earcup (such as another earcup 100, the second earcup or the third earcup as described herein) included in the same set of headphones 1000 as the earcup 100; one or more signal processors, which are optionally also connected to the another earcup; one or more drivers borne by the another earcup; one or more sensors; an actuator of the another earcup; an audio input device, which is optionally also connected to the another earcup; an ambient noise cancellation module and/or other active acoustic isolation apparatus; one or more microphones; a telecoil (T-coil); one or more other components described herein or otherwise readily apparent to the skilled addressee. In some examples, the earcup 100 may be considered to include the one or more signal processors, the one or more sensors, the ambient noise cancellation module, a T-coil, one or more other components etc. The connections 105 may include mechanical connections, digital or analogue electrical connections, wired or wireless electrical connections. In some examples, the connections 105 include a personal area network (PAN), such as a piconet or a wireless PAN (WPAN), by which input audio signals are received in use from the audio input device. In some examples, the connections 105 include or are otherwise electrically connected to a plug of the headphones 1000. The plug may be configured to detachably mate with a jack through which input audio signals are received in use from an audio input device, wherein the jack is disposed in the audio input device.

The earcup 100 may be considered to be in any one of at least three states at any given point in time: an open state, a closed state, and a transitional state between the open state and the closed state. As mentioned, the earcup 100 is in the closed state in FIG. 1(a) and the earcup 100 is in the open state in FIG. 1(b). Furthermore, the earcup 100 is operable, by the actuator 102, to alternate between being in the open state and the closed state. In other words, upon operation of the earcup 100 in the open state by an actuator 102, the earcup 100 moves or otherwise transitions from the open state to the closed state (via a transitional state therebetween); and likewise, upon operation of the earcup 100 in the closed state by an actuator 102, the earcup 100 moves or otherwise transitions from the closed state to the open state (via a transitional state therebetween). When the earcup 100 is in a transitional state, it is neither fully in the open state or the closed state and instead is in an intermediate state, which typically occurs while the earcup 100 is being operated by an actuator 102 to alternate between states.

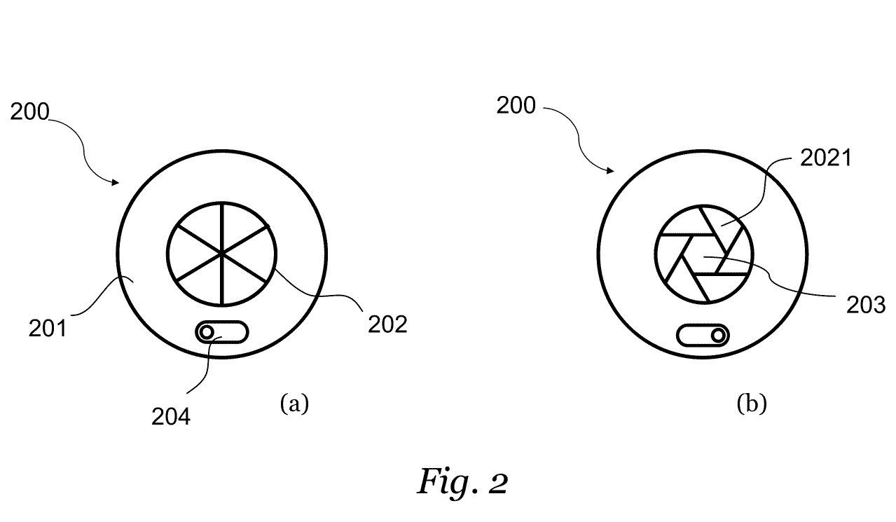

When the earcup 100 is in the open state, the housing 101 is arranged in an open-back configuration (e.g. to permit airflow through the housing 101). An open-back configuration is understood to include a semi-open back configuration or a semi-closed back configuration. When the earcup 100 is in the closed state, the housing 101 is arranged in a closed-back configuration (e.g. to completely or hermetically arrest or otherwise impede airflow through the housing 101). To provide a housing 101 which can assume two such configurations, the housing 101 may include specialised means for permitting airflow through the housing 101 when the housing 101 is in the open-back configuration and arresting airflow through the housing 101 when the housing 101 is the closed-back configuration. In some examples, such means may include a variably configurable grille (e.g. a mesh, lattice, or other such framework) which is connected to and configurable by the actuator 102. In some examples, such means may include a camera lens-type aperture mechanism (described with reference to FIG. 2) which is connected to and configurable by the actuator 102. In some examples, such means may include a detachable / reattachable plate which is connected to and configurable by the actuator 102.

In the example of FIG. 1, the housing 101 includes a grille and an inner volume 1012. The grille may be formed of one or more moveable blades corresponding to one or more respective variable apertures 1011, or one or more sets of moveable blades where each set corresponds to the respective one or more variable apertures 1011. In any case, the one or more blades may be considered to define the one or more variable apertures 1011. When an aperture is in its open position, the blade or set of blades corresponding thereto is arranged at the aperture such that the aperture is unsealed, and airflow is permitted to pass therethrough. When each of the one or more apertures 1011 is in its open position (i.e. open or otherwise unsealed), the housing 101 is in the open-back configuration as in FIG. 1(b). When an aperture is in its closed position, the blade or set of blades corresponding thereto is arranged at the aperture such that the aperture is sealed, and airflow is prevented from passing therethrough. When each of the one or more apertures 1011 is in its closed position (i.e. sealed), the housing 101 is in the closed-back configuration as in FIG. 1(b).

The inner volume 1012 may be pneumatically connected to the canal 12 (i.e. airflow may pass between the inner volume 1012 and the canal 12). The inner volume 1012 may be formed of a hollow space within the earcup 100 between the driver 103 and the housing 101 and/or may be formed of the sum of several interstitial spaces within the earcup 100 anywhere between the canal 12 and the housing 101. In FIG. 1(b), two variable apertures 1011 are shown in their open positions; in FIG. 1(a), the two apertures 1011 are also included in the housing 101 but are shown in their closed positions and so are not visible in the drawing. The number of blades / apertures are not limited herein; however typically there are provided multiple blades defining a corresponding multiple apertures. When in the open-back configuration, the housing 101 permits airflow between the ambient environment and the inner volume 1012 via the one or more apertures 1011 in their open positions. Therefore, ambient sound can pass from the ambient environment to the inner volume 1012, and sound reproduced by the one or more drivers of the headphones 1000 can pass from the inner volume 1012 to the ambient environment. When in the closed-back configuration, the housing 101 arrests airflow between the ambient environment and the inner volume 1012 via the one or more apertures 1011 by said apertures being in their closed positions. Therefore, ambient sound cannot pass or is at least impeded from passing from the ambient environment to the inner volume 1012, and sound reproduced by the one or more drivers of the headphones 1000 cannot pass or is at least impeded from passing from the inner volume 1012 to the ambient environment.

The one or more moveable blades may be or otherwise include one or more respective slats, shutters, bars, or doors, which may or may not be slidable with respect to each other. As mentioned, in some examples the housing 101 includes a plurality of moveable blades. The multiple moveable blades 1011 may be collectively or individually operable, by the actuator 102, to alternate between being in their open positions and their closed positions. When collectively operable, the multiple blades may be connected to one another (e.g. by one or more mechanical linkages, bearings etc.) such that, upon operation of the actuator 102 connected to at least one of the multiple blades (e.g. via the one or more mechanical linkages, bearings etc.), the blades of the housing 101 are induced to move in unison between the open-back configuration and the closed-back configuration. For example, the multiple blades may move in unison with respect to one another by sliding over each other. In such examples, the multiple blades may be slidably connected to one another such that the multiple blades are operable to slide with respect to one another while transitioning between the open-back configuration and the closed-back configuration. When individually operable, each blade may be induced to move between its open position and its closed position independently of other blades. This may permit greater flexibility in deciding the amount of airflow permitted while in the open state. For example, each blade may include a manual actuator (e.g. grip or handle disposed thereon), the manual actuator being operable by a user to open and close said blade. Alternatively, each blade may be independently operated by an electronically operated actuator to open and close said blade.

Optionally, one or more lips are disposed on the respective one or more moveable blades, the one or more lips being configured so as to form a hermetic (i.e. airtight) seal with each other and/or with the one or more variable apertures 1011 when the earcup 100 is in the closed state. Additionally or alternatively, one or more lips are disposed on the respective one or more variable apertures 1011, the one or more lips being configured so as to form a hermetic seal with each other and/or with the one or more moveable blades when the earcup 100 is in the closed state.

The actuator 102 may be any mechanical actuator known in the art which is suitable for connecting to the housing 102 and in use operating the housing 102 between the closed-back and open-back configurations. The actuator 102 may be electrically operable (i.e. able to be operated purely electronically), mechanically operable (i.e. able to be operated purely manually), or a hybrid (i.e. able to be operated manually and electronically). In some examples, the actuator 102 may include a mechanism connected to the housing 101 (and optionally the one or more blades thereof) by which the actuator 102 can configure the housing 101 into a respective configuration. The mechanism may include one or more mechanical linkages.

In the case of a manual actuator 102, the actuator 102 may include a handle or grip connected to the mechanism and preferably to at least one of the one or more linkages. In some examples, actuation of the handle / grip may take place by a user. In the case of an electronic actuator 102, the actuator 102 may include a motor connected to the mechanism, preferably to at least one of the one or more linkages, and optionally to a battery of headphones 1000 or the earcup 100 thereof. In some examples, actuation of the motor may be initiated by a switch electrically connected to the actuator, such as a button on the audio input device or a user-operated switch (not shown) disposed on the housing 101 or an outer surface thereof. In any case, upon actuation of actuator, the mechanism is such that the earcup 100 moves or otherwise transitions either from the open state to the closed state (via a transitional state therebetween) or from the closed state to the open state (via a transitional state therebetween) as described herein. Once the state change has occurred, actuation of the given actuator 102 may cease until the next state change is required.

In some examples, once the earcup 100 has assumed a given state, it is desired to further secure the earcup 100 from assuming a transitional state or otherwise changing state until so required. Preferably, the earcup 100 includes a latch mechanism to address this. The latch mechanism is configured to secure the earcup 100 in one of the open state or the closed state. Preferably, the latch mechanism includes a magnet array, the magnet array including multiple magnets arranged on the housing 101 (optionally on the one or more blades and/or one or more apertures 1011) such that the housing 101 is secured, by magnetic forces, in the open-back configuration when the earcup 100 is in the open state and in the closed-back configuration when the earcup 100 is in the closed state.

The earcup 100 may be connected (e.g. via connection 105) to one or more signal processors, such as a first signal processor, a second signal processor, and/or a third signal processor as hereinafter described. Typically, the earcup 100 includes the one or more signal processors; alternatively, the headphones 1000 include the one or more signal processors separate but connected to the earcup 100; alternatively still, the audio input device includes the one or more signal processors which can communicably connect to the headphones 1000 (and thereby the earcup 100 by connection 105). When there is provided at least two such processors, the at least two processors may be distinct audio signal processors or may be sub-units / functions of one multifunctional audio signal processor.

In some examples, there is a first signal processor configured to estimate a noise level at the earcup 100. The estimation may be based on ambient noise collected in the proximity of the earcup 100 and may or may not include the noise floor of the headphone circuitry. For example, a microphone of the headphones 1000 is configured to collect ambient noise, wherein the microphone is borne by the earcup 100 (i.e. positioned at or within the earcup 100) or the microphone is positioned elsewhere on the headphones 1000, such as at a distal end of a boom; additionally or alternatively, a microphone of the audio input device (e.g. a mobile phone, a computer etc. as described herein) is configured to collect the ambient noise, wherein the microphone is connected to the headphones 1000, such as via a jack.

In further examples, the first signal processor is configured to control the actuator 102 (e.g. using control command signals or other control instructions) to operate the earcup 100 between the open and closed states based on the estimated noise level. For example, when the noise level is estimated to be greater than a threshold, the first signal processor is configured to send a control command signal to the actuator 102 to operate the one or more blades (corresponding to one or more hitherto unsealed apertures 1011) to close such that the earcup 100 assumes the closed state; when the noise level is estimated to be less than a threshold, the first signal processor is configured to send another control command signal to the actuator 102 to operate the one or more blades (corresponding to one or more hitherto sealed apertures 1011) to open such that the earcup 100 assumes the open state. In this way, the earcup 100 is adapted based on the ambient noise near the user’s ear 1 in order to provide the optimum listening experience in the given scenario. Once the state change has occurred, the housing 101 may be configured to remain in the new state (and the operation of the actuator 102 may cease) until the next state change is required. This may be achieved by a latch mechanism or by sending further control instructions to the actuator as described herein.

The threshold(s) at which the first signal processor sends the respective control command signals to the actuator 102 may be the same or different and may be predetermined, dynamically determined, and/or determined based on data. For example, the first signal processor may be configured to determine such a threshold based on user preference data or empirical audio data; alternatively, the threshold is a predetermined device parameter of the headphone model or audio input device model which is provided to the first signal processor. In some examples of using user preference data, the threshold may be one of multiple user preference settings of the headphones 1000 which the user can select on start-up, on setup, or during use of the headphones 1000. In some examples of using empirical data, the threshold may be a predetermined setting of the headphones 1000 based on the maximum ambient noise level at which the quality of sound reproduction for the user in an open-back configuration would be so diminished as to warrant a closed-back configuration. In this way, the earcup 100 is configured based on useful sources of data, such as user data or experimental data, which inform how the earcup 100 is optimally adapted at any given noise level. This is useful in both electroacoustic devices where interference from background noise is desirable and earmuffs / ear defenders where protection of the eardrum from loud external noises is paramount.

In yet further examples, the first signal processor is configured to determine a denoise signal (or ‘anti-noise’ signal) for use in active acoustic isolation based on the collected ambient noise and/or the estimated noise level at the earcup 100. The denoise signal is configured to counteract ambient noise in the proximity of the earcup 100 (and preferably the ear 1 in use) which could otherwise diminish the quality of sound reproduction or the overall auditory experience of headphones 1000 for the user. In use, the first signal processor is configured to send the denoise signal, optionally together with the input audio signal, to the driver 103 (e.g. for outputting to the user as an output audio signal). For example, an ambient noise cancellation module of (or otherwise connected to) the first signal processor receives the ambient noise collected as described herein and, based on the ambient noise, generates the denoise signal.

Additionally or alternatively, the first signal processor is configured to determine whether to turn on or turn off active acoustic isolation based on the estimated noise level. For example, when the noise level is estimated to be greater than a threshold, the first signal processor is configured to send a control command signal to the ambient noise cancellation module to generate the denoise signal for use in active acoustic isolation (e.g. in order to turn on active acoustic isolation); when the noise level is estimated to be less than a threshold, the first signal processor is configured to send another control command signal to the ambient noise cancellation module to cease (i.e. stop generating or otherwise stop sending) the denoise signal (e.g. in order to turn off active acoustic isolation). These threshold(s) may be the same as or different to the threshold(s) used for sending the control command signals based on the estimated noise level as described hitherto. In this way, active acoustic isolation can be applied or suspended at specific noise levels based on useful sources of data without need for the user to manually adjust the headphone device settings during use.

In some examples, there is a second signal processor configured to modify the to-be-output audio signal and/or the denoise signal and thereby generate a modified input audio signal and/or a modified denoise signal, respectively, based on the detected state of the earcup 100. The second signal processor is then configured to provide the modified signal(s) to the driver 103 (e.g. for transducing, outputting, and thereafter listening by the user) based on the current earcup state. In this way, the output audio signal reproduced by the driver 103 is modified according to the current earcup state.

The earcup 100 may be configured to detect, recall, or otherwise identify the current earcup state. For example, there may be provided a sensor on the housing 101 of one or both earcups 100 of the set of headphones 1000, the sensor being configured to sense or otherwise determine whether the housing 101 is in the open-back or closed-back configuration and to send a sensor signal based on the sensed state to the second signal processor, wherein the sensor signal is indicative of the current earcup state. The sensor may be a component part of the earcup 100 or may be a component part of the headphones 1000 (or an external device such as an audio input device) which is electrically connected to the earcup 100. In this way, the second signal processor can identify the current earcup state based on the sensor signal received from the sensor.

For example, when the closed state is detected, the second signal processor is configured to apply a first modification transform to the input audio signal to generate a first modified audio signal, wherein the first modification transform is a function or factor configured to optimise the quality of sound reproduction for the user in a closed-back configuration; when the open state is detected, the second signal processor is configured to apply a second modification transform to the input audio signal to generate a second modified audio signal, wherein the second modification transform is a function or factor configured to optimise the quality of sound reproduction for the user in an open-back configuration. Additionally or alternatively, when the closed state is detected, the second signal processor is configured to apply a third modification transform to the denoise signal to generate a first modified denoise signal, wherein the third modification transform is a function or factor configured to optimise acoustic isolation for the user in a closed-back configuration; when the open state is detected, the second signal processor is configured to apply a fourth modification transform to the denoise signal to generate a second modified denoise signal, wherein the fourth modification transform is a function or factor configured to optimise acoustic isolation for the user in an open-back configuration. In both cases, the second signal processor is then configured to provide the first or second modified signals to the driver 103 depending on which earcup state is detected.

The first and second modified audio signals represent input audio signals optimised for use in the respective closed and open earcup states. This may include said signals being optimised for a high-quality listening experience in the respective closed and open earcup states and/or a high power efficiency performance in the respective closed and open earcup states. Optimisation of sound reproduction quality and/or power efficiency in the respective earcup states may be based on empirical or modelled audio data (e.g. data derived from testing the audio output signal quality and/or power usage of the headphones 1000 in the respective earcup states and/or data provided for the specific headphone model or design). Additionally or alternatively, other headphone performance metrics are used to optimise the received input audio signal for optimum reproduction in a given earcup state. Therefore, the modification transforms are usefully based on empirical or modelled audio data for the headphones 1000.

In additional or alternative examples, based on the identified state of the earcup 100, the second signal processor is configured to turn on or turn off active acoustic isolation. For example, when the closed state is detected, the second signal processor is configured to send a control command signal to the ambient noise cancellation module to generate the denoise signal for use in active acoustic isolation (e.g. in order to turn on active acoustic isolation); when the open state is detected, the second signal processor is configured to send another control command signal to the ambient noise cancellation module to cease (i.e. stop generating or otherwise stop sending) the denoise signal (e.g. in order to turn off active acoustic isolation). In this way, active acoustic isolation is applied only in the earcup state in which it is found to be most effective for the desired listening experience i.e. in the closed-back configuration where an intimate soundstage is desirable.

In some examples, there is a third signal processer configured to control the actuator 102 (e.g. using control command signals or other control instructions) to operate the earcup 100 between the open state and the closed state based on the received input audio signal. For example, the third signal processor is configured to determine one or more audio characteristics of the input signal received from the input audio device, wherein third signal processor may be configured to receive the characteristics from the audio input device or may be configured to dynamically calculate the characteristics. The one or more audio characteristics include but are not limited to: amplitude, volume, transients, bandwidth, harmonics, pitch, dynamic range, signal-to-noise ratio, clarity, stereo width, specialisation. The third signal processor is then configured to send respective control command signals to the actuator 102 to operate the earcup 100 between the open state and the closed state based on the determined one or more audio characteristics of the received input audio signal. In this way, the earcup 100 is adapted based on the input audio itself and in particular whether that audio is best suited to listening in a closed-back or open-back configuration.

In further examples, the third signal processor is configured to compare the one or more audio characteristics (or all or a subset of multiple audio characteristics) to one or more respective audio criteria. An audio criterium may be predetermined and may be indicative of either the optimum value of a given audio characteristic for sound reproduction when the earcup 100 is in the open state or the optimum value of a given audio characteristic for sound reproduction when the earcup 100 is in the closed state. As mentioned previously, optimisation of sound reproduction may be based on quality, power efficiency, or another headphone performance metric in the respective states.

Upon comparison of the audio characteristics to the respective audio criteria, the third signal processor is configured to determine whether sufficient audio characteristics meet the corresponding audio criteria (or come within a predetermine range of said criteria) for sound reproduction in a given state, and thereby determine which state is optimal or otherwise suitable for reproduction of the received input audio signal. For example, when the third signal processor determines that the received audio input meets the audio criteria for the closed state, the third signal processor is configured to send a control command signal to the actuator 102 to operate the one or more blades (corresponding to one or more hitherto unsealed apertures 1011) to close such that the earcup 100 assumes the closed state; when the third signal processor determines that the received audio input meets the audio criteria for the open state, the third signal processor is configured to send another control command signal to the actuator 102 to operate the one or more blades (corresponding to one or more hitherto sealed apertures 1011) to open such that the earcup 100 assumes the open state.

According to FIG. 2, there is provided an earcup 200. The earcup 200 includes at least a housing 201 and an actuator (not shown). In FIG. 2(a), the earcup 200 is in the closed state. In FIG. 2(b), the earcup 200 is in the open state. The earcup 200 may also be arranged in use in headphones 1000 as will be readily apparent to the skilled addressee. The drawings show an outer surface of the housing 201 that is away from the ear 1 in use and, accordingly, the actuator disposed within the earcup 200 is not visible.

In the example of FIG. 2, the housing 201 includes a camera lens-type aperture mechanism 202, rather than a grille as described with reference to FIG. 1, or a detachable plate. In other words, the earcup 200 is an embodiment of the earcup 100 having a single variably configurable aperture per earcup and having an exemplary means to achieve opening and closing (i.e. the aperture mechanism 202). Accordingly, the earcup 200 may have any of the features and functionalities described with reference to FIG. 1 (e.g. in addition to or instead of those described with reference to FIG. 2), the descriptions of which are not repeated hereinafter for brevity. Likewise, the headphone to which the earcup 200 is applied may have any of the additional components (e.g. connected to or included in the earcup 200 or otherwise) described hitherto with reference to FIG. 1.

In some examples, the aperture mechanism 202 may be in the form of an iris diaphragm (also referred to as a mechanical iris or iris shutter mechanism) which is operable, by the actuator, between being in either an open position or a closed position. The typical structure and operation of an iris diaphragm is known in the art and is not described in detail herein. However, it suffices that the aperture mechanism 202 is formed of multiple slidably connected blades arranged in the form of an iris. One such blade 2021 is labelled in FIG. 2(b). The multiple blades are interconnected in such a manner as to slide with respect to one another to form either a substantially hollow opening 203 in its open position (as shown in FIG. 2(b)) or a sealed, radially arranged palisade in its closed position (as shown in FIG. 2(a)).

In the case of a manual actuator, the actuator may include a handle or grip connected to the aperture mechanism 202 and disposed on an outer surface of the housing 201 such that actuation of the handle / grip may take place by a user. In the case of an electronic actuator, the actuator may include a motor connected to the aperture mechanism 202 (and optionally to a battery of headphones 1000 or the earcup 100 thereof). In such examples, actuation of the motor may be initiated by a switch electrically connected to the actuator, such as a button on the audio input device or a user-operated switch 204 disposed on the housing 201 or an outer surface thereof. The user-operated switch 204 is set to ‘CLOSED’ in FIG. 2(a) and set to ‘OPEN’ in FIG. 2(b), thereby corresponding to the closed and open earcup states respectively.

Additionally or alternatively, the housing 201 is rotatable with respect to the headphones to which it is applied and, upon rotation of the housing 201 in a first direction, the aperture mechanism 202 is configured to open and, upon rotation of the aperture mechanism 202 in a second direction, the aperture mechanism is configured to closed, wherein the first and second directions have opposite sense of rotation. The housing 201 may be rotatable by the user (e.g. using a grip disposed on at least part of an outer surface of the housing 201) or by the motor (e.g. using a switch as described herein).

In any case, upon actuation of the actuator, the aperture mechanism 202 is induced to move or otherwise transition either from its open position in FIG. 2(b) to its closed position in FIG. 2(a) (via a sliding state therebetween) or from its closed position in FIG. 2(a) to the open position in FIG. 2(b) (via a sliding state therebetween), whereby to alternate between the respective open and closed states of the earcup 200. Typically, the multiple blades are induced to move in unison between the iris’ open and closed positions. Once the state change has occurred, actuation of the given actuator may cease until the next state change is required.

The foregoing descriptions are mere examples of the invention and are not intended to limit the protection scope of the present disclosure. Though the description of each embodiment has its own emphasis, for any feature, example or advantage that is not described in relation to one embodiment, reference may be made to related descriptions of any other embodiments. Any variation, replacement or other embodiment within the scope of the claims hereto appended shall fall within the protection scope .

What is claimed is:

1. An earcup for a set of headphones, the earcup comprising: an actuator and a housing, wherein the earcup is operable, by the actuator, to alternate between being in an open state and a closed state, wherein the housing is arranged in an open-back configuration when the earcup is in the open state, and the housing is arranged in a closed-back configuration when the earcup is in the closed state.

2. The earcup of claim 1, wherein the housing is configured to arrest airflow through the housing when the earcup is in the closed state, and to permit airflow through the housing when the earcup is in the open state.

3. The earcup of claim 1, wherein the housing is configured to form a hermetic seal when the earcup is in the closed state.

4. The earcup of claim 1, wherein the housing comprises one or more moveable blades, the one or more blades being operable, by the actuator, to move between the open-back configuration and the closed-back configuration whereby to alternate the earcup between being in the open state and the closed state respectively.

5. The earcup of claim 4, wherein the one or more moveable blades comprises a plurality of moveable blades, the plurality of blades being connected to one another such that the plurality of blades are operable to move in unison between the open-back configuration and the closed-back configuration.

6. The earcup of claim 5, wherein the plurality of blades are slidably connected to one another such that the plurality of blades are operable to slide with respect to one another whereby to move between the open-back configuration and the closed-back configuration.

7. The earcup of claim 4, wherein the one or more blades are in the form of a mechanical iris.

8. The earcup of claim 4, wherein one or more lips are disposed on the respective one or more blades, the one or more lips being configured so as to form a hermetic seal when the earcup is in the closed state.

9. The earcup of claim 11 wherein the actuator is an electronically operated actuator.

10. The earcup of claim 9, wherein the earcup is operable, by the actuator, to alternate between being in the open state and the closed state upon actuation, by a user, of a switch.

11. The earcup of claim 1, wherein the actuator is a manually operated actuator.

12. The earcup of claim 11, wherein the housing comprises one or more moveable blades, the one or more blades being operable, by the actuator, to move between the open-back configuration and the closed-back configuration, and the actuator comprises a handle connected to at least one of the one or more blades whereby the earcup is manually operable to alternate between being in the open state and the closed state.

13. The earcup of claim 11, wherein the housing comprises an attachable and detachable plate, one or more attachment features corresponding to the plate, and one or more apertures, wherein the plate is configured to attach to and detach from the earcup by the one or more corresponding attachment features, the plate when attached is configured to cover the aperture(s) so as to provide the closed-back configuration, and the plate when detached is configured to uncover the aperture(s) so as to provide the open-back configuration.

14. The earcup of claim 1, wherein the earcup comprises a latch mechanism, the latch mechanism being configured to secure the earcup in one of the open state and the closed state.

15. The earcup of claim 14, wherein the latch mechanism comprises a magnet array, the magnet array comprising a plurality of magnets arranged on the housing such that the housing is secured, by magnetic forces, in the open-back configuration when the earcup is in the open state and in the closed-back configuration when the earcup is in the closed state.

16. The earcup of claim 1, wherein the earcup is configured to bear a microphone, the microphone being configured to collect ambient noise in the proximity of the earcup.

17. The earcup of claim 16, wherein the actuator is an electronically operated actuator, and the earcup comprises a signal processor, the signal processor being configured to estimate a noise level at the earcup based on the ambient noise collected by the microphone, and to control the actuator to operate the earcup between the open state and the closed state based on the estimated noise level.

18. The earcup of claim 17, wherein the signal processor is configured to determine a denoise signal based on the estimated noise level, the denoise signal being configured to counteract the ambient noise in the proximity of the earcup.

19. The earcup of claim 18, wherein the earcup is configured to bear a driver, and the signal processor is configured to output, by the driver, the denoise signal.

20. The earcup of claim 1, wherein the earcup is configured to bear a driver, the driver being configured to output an output audio signal according to a received input audio signal.

21. The earcup of claim 20, wherein the earcup comprises a signal processor, the signal processor being configured to modify the to-be-output audio signal based on the detected state of the earcup.

22. The earcup of claim 20, wherein the actuator is an electronically operated actuator, and the earcup comprises a signal processer, the signal processor being configured to receive the input audio signal, and to control the actuator to operate the earcup between the open state and the closed state based on the received input audio signal.

23. A set of headphones comprising: one or more earcups for the set of headphones, the earcup comprising: an actuator and a housing, wherein the earcup is operable, by the actuator, to alternate between being in an open state and a closed state, wherein the housing is arranged in an open-back configuration when the earcup is in the open state, and the housing is arranged in a closed-back configuration when the earcup is in the closed state.

24. The set of headphones of claim 23, wherein the set of headphones comprises two earcups, each earcup comprising an actuator and a housing, and the earcups being operable, by their respective actuators, to alternate between being in an open state and a closed state, wherein both housings are arranged in open-back configurations when the earcups are in the open state, and both housings are arranged in closed-back configurations when the earcups are in the closed state.

25. The set of headphones of claim 23, wherein the set of headphones comprises an actuator and two earcups, each earcup comprising a housing, and the earcups being operable, by the actuator, to alternate between being in an open state and a closed state, wherein both housings are arranged in open-back configurations when the earcups are in the open state, and both housings are arranged in closed-back configurations when the earcups are in the closed state.

26. The set of headphones of claim 23, wherein the set of headphones comprises a switch connected to the actuator(s), wherein the one or more earcups are operable, by the actuator, to alternate between being in the open state and the closed state upon actuation, by a user, of the switch.
